(19) United States
(12) Patent Application Publication
(10) Pub. No.: US 2017/0255884 A1
(43) Pub. Date: Sep. 7, 2017

(54) SYSTEM AND METHOD FOR SPATIAL AND VISUAL PROCESSING IN COGNITIVE ARCHITECTURE

(71) Applicant: Omprakash VISVANATHAN, Chennai (IN)

(72) Inventor: Omprakash VISVANATHAN, Chennai (IN)

(21) Appl. No.: 15/231,667

(22) Filed: Aug. 8, 2016

(30) Foreign Application Priority Data
Mar. 7, 2016 (IN) 201641007879

(51) Int. Cl. G06Q 10/06; G06F 17/30

(52) U.S. Cl. CPC G06Q 10/067; G06F 17/3056

(57) ABSTRACT

The present disclosure relates to a method and system for spatial and visual processing in cognitive architecture that involves an artificial intelligence method for learning and problem solving. The cognitive agent business rule system or the system comprises an application server in communication with one or more external devices, wherein the application server further comprises; a cognitive agent module, configured to compose and execute a plurality of business rules; at least a first database for storing a one of preference operators, an episodic data and the like, and wherein the at least first database is in communication with the cognitive agent; a second database for storing a visual data received from and to be sent to the external devices; wherein the cognitive agent processes the visual data using one or more operators and episodic data received from the first database.

### CROSS-REFERENCE TO RELATED APPLICATIONS

This non-provisional application claims priority to Indian Provisional Patent Application No. 201641007879, filed on Mar. 7, 2016, which is incorporated herein by reference in its entirety.

### TECHNICAL FIELD

The present disclosure in general relates to learning and problem solving systems and more particularly, to a method and system for spatial and visual processing in cognitive architecture that involves an artificial intelligence method for learning and problem solving.

### BACKGROUND

With an increasing development in the field of artificial intelligence, concept of the cognition has been increasingly used for learning and problem solving. The cognition refers to human facility/capacity to engage in multi-step reasoning, to understand the meaning of natural language, to design innovative artifacts and to learn and generate novel plans for problem solving. Generally, cognitive modules/agents deal with intelligent behavior, learning and adaptation in machines. The cognitive modules comprise multiple structurally organized cognitive processes that enlist how data/information from the environment is acquired and analyzed and how the decisions are made based on the acquired and analyzed data.

Cognitive modules include performance models that represent human knowledge and information manipulation processes. Such models attempt to represent and simulate the mental or cognitive processes underlying human behavior. These models are typically based on theories of cognition that describe how knowledge is accessed, represented, and manipulated in human minds.

In general, cognitive systems solves facilitate decision making such as if and when to perform certain condition based responsive activity, including logistics and maintenance activity in response to a known and/or anticipated condition. Further, the cognitive systems employ various techniques for implementing behavior and decision making capabilities.

While much work has been done on implementing the cognitive architecture by the way of standalone web applications, services running on a distributed computing platform etc., one challenge present in the art is to develop a cognitive architecture that is comprehensive and covers the full range of human cognition including decision making based on visual feeds and natural language feeds. Current approaches are not able to provide such a comprehensive architecture. Architectures developed to-date typically solves single and multiple modal problems that are highly specialized in function and design. Such architectures lack detailed theories of speech perception, perceptual recognition, spatial and visual recognition, mental imagery etc.

### SUMMARY OF THE INVENTION

This summary is provided to introduce aspects related to method(s) and system(s) for spatial and visual processing in cognitive architecture that involves an artificial intelligence method for learning and problem solving and the aspects are further described below in the detailed description. This summary is not intended to identify essential features of the claimed subject matter nor is it intended for use in determining or limiting the scope of the claimed subject matter.

The present disclosure relates to a method and system for spatial and visual processing in cognitive architecture that involves an artificial intelligence method for learning and problem solving. The cognitive agent business rule system or the system comprises an application server in communication with one or more external devices, wherein the application server further comprises; a cognitive agent module, configured to compose and execute a plurality of business rules; at least a first database for storing a one of preference operators, an episodic data and the like, and wherein the at least first database is in communication with the cognitive agent; a second database for storing a visual data received from and to be sent to the external devices; wherein the cognitive agent processes the visual data using one or more operators and episodic data received from the first database.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1A illustrates a cognitive agent business rule system 100 for showing interaction of an application server comprising a cognitive agent module with one or more external devices in accordance with various embodiments of the present disclosure.

FIG. 1B illustrates REST API design for communication between the external devices and the application server in accordance with an embodiment of the present disclosure.

FIG. 1C is an example block diagram illustrating micro-service architecture in accordance with an embodiment of the present disclosure.

FIG. 2 is a block diagram of an example cognitive agent module 104 for solving problems involving spatial and visual processing in accordance with an embodiment of the present disclosure.

FIGS. 3A and 3B illustrates an exemplary processing by the spatial and visual agent 214 in accordance with an embodiment of the present disclosure.

FIG. 4 is a flowchart describing the execution of the plurality of business rules by the cognitive agent module 104 in accordance with various embodiments of the present disclosure.

FIG. 5 illustrates an application of the cognitive agent module and the spatial and visual agent in autonomous driving vehicle in accordance with an embodiment of the present disclosure.

FIG. 6 illustrates an example Sudoku puzzle with marked-up cells.

FIG. 7 illustrates an example sub graph search method in accordance with an embodiment of the present disclosure.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying figures.

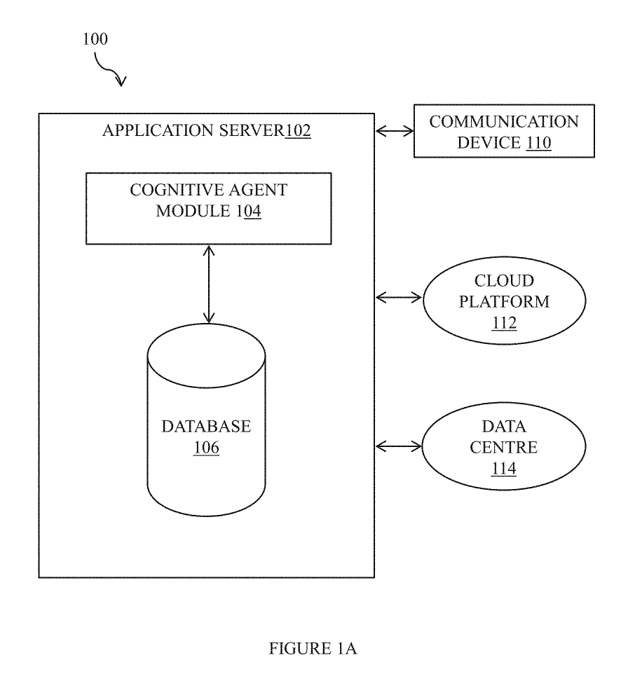

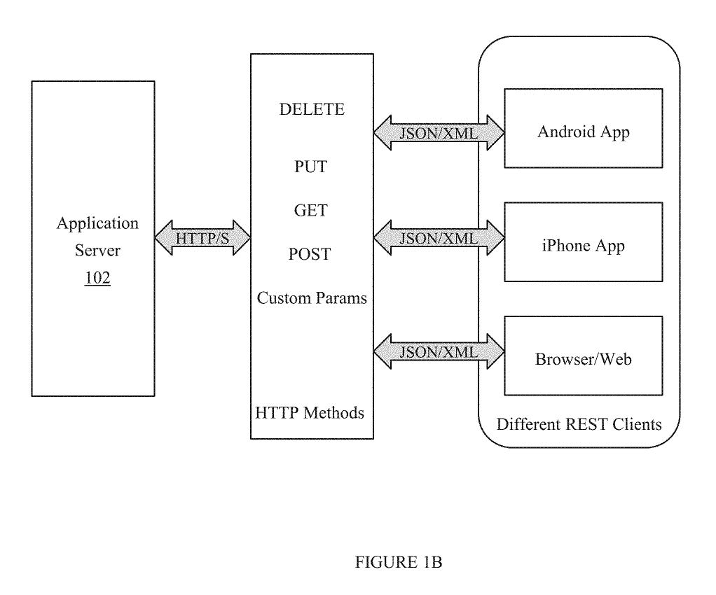

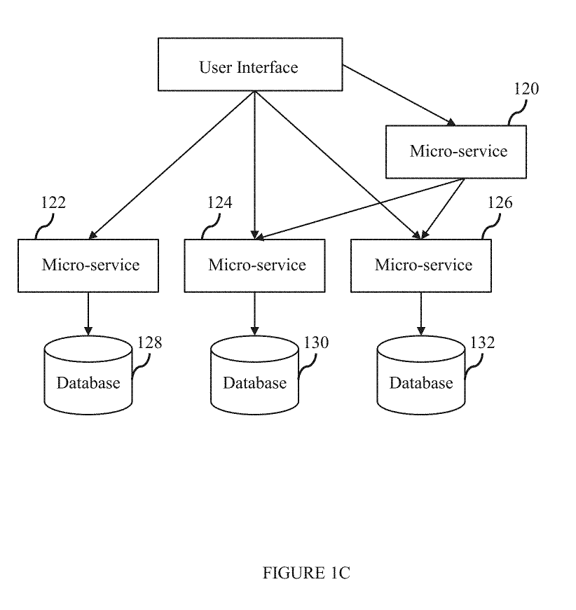

FIG. 1A illustrates a cognitive agent business rule system 100 for showing interaction of an application server comprising a cognitive agent module with one or more external devices in accordance with various embodiments of the present disclosure. It is understood that the external device may include but not limited to a communication device 110, a cloud platform 112 and a data center 114 through which a user may communicate with the application server 102. In accordance with an embodiment of the present disclosure, the application server 102 is built in Node.js, a JavaScript runtime environment. However, the application server 102 may be implemented in C/C++, Java, and other scripting languages like MVEL etc. As shown, the application server 102 comprises a cognitive agent module 104 and a database 106 (a first database).

In accordance with an embodiment of the present disclosure, the database 106 (first database) comprises business rules, preference data, and episodic data and allows individuals/users to use business rules through the cognitive agent module 104. On the other hand, the business rules are stored in files.

Further, in accordance with an embodiment of the present disclosure, the application server 102 comprises one or more application program interfaces (APIs) for example REST API, which enables exchanging services and service requests between the cognitive agent module 104 and the one or more external devices (110-114). On the other hand, the communication may be established through cognitive agent methods directly or through other means such as http calls, RPC (remote procedure calls) calls and alike. In one implementation, the REST API communicates one or more requests (for example, queries) from the external devices to the cognitive agent module 104 and returns responses through one or more events to event listeners present in the one or more external devices (110-114). Hence the services are REST services made available as REST endpoints in contrast to the services being exposed as XML web services. The services are exposed as REST resources and information is transmitted across the wire in plain text format as either XML or JSON. FIG. 1B illustrates REST API design for communication between the external devices and the application server in accordance with an embodiment of the present disclosure. As shown, services are exposed as REST resources and information is transmitted across the wire in plain text format as either XML or JSON. Further, interfaces may be employed if the resource is already extending a REST or RPC service to accommodate the multi service scenario. Using plain text for the messages enables interoperability as services defined and written using one technology say java may be called and accessed by a program written in another e.g. C#.

It is to be noted that the communications established by the cognitive agent methods via RPC calls are more advantageous. Unlike REST API, RPC uses TCP/IP protocol and enables encryption of messages, this is particularly useful when calling remote clients. RPC is preferable over REST in closed networks such as intranet etc. Since RPC services are not interoperable, the application server 102 provides multiple implementations to enable exchange of services and service requests between the cognitive agent module 104 and one or more external devices. For example, the dispatcher servlet is configured to determine the type of service being handled, such as .htm file, .rpc requests, presence of /rest/ in the address and the like. In another example, both the RPC and REST calls are mapped to the same CustomerService.save( ) method. In yet another example, the RPC and REST calls are saved differently as in CustomerService.save( ), CustomerService.saverest( ).

Further, to enable usage of such arrangement in Java programs, the RPC service is extended as a RemoteService instead of a RemoteServiceServlet. The service is then bind to a common servlet using declarative means such as config files, annotations etc. Another important attribute of RPC service is the serializing and deserializing of messages at both client and server side. Serialization is the act of converting methods and method parameters to a format suitable for transmission and deserialization refers to process of converting received messages back to the format comprising objects, classes etc.

In one implementation, the application server 102 comprises a centralized service registry where services are registered. The services may auto register themselves and the clients may then query the registry by the service name, service keyword, domain name etc. to retrieve the service/services they wish to call. In another implementation, the cognitive agent module supports ‘Gin and Rummy’ messaging. The message sender sends a message without specifying a destination queue or address and any of the receivers may pick up the message based on some keyword. The message must be accompanied by a publicly visible keyword, tags, intro text, description etc. which the receiver may see clearly before picking up a message. The receiver shall also have the option of peeking at a message without retrieving it from the queue to conserve resources. In another alternative implementation, the cognitive agent module supports “Lost and Found” messaging wherein the messaging application persists the message in a durable, long term queue if no receiver has opted to pick up the message within the specified time. The scheduler task then runs at periodic intervals and may unpersist and persist these messages depending on any interested receivers.

In one implementation, a client opens a connection through the external devices and sends a request (for example, http request) to the application server 102. In turn, the server sends responses and closes the connection once the response is fully sent. In another implementation, the cognitive agent business rule system 100 implements Sever-Sent Events (SSE) that allows the application server 102 to asynchronously push the data from the application server 102 to the client once the client-server connection is established by the client. Once the connection is established by the client, the application server 102 provides the data and decides to send the data to the client whenever new “chunk” of data is available. When a new data event occurs on the application server 102, the data event is sent by the application server 102 to the client. Hence SSE reuses the connection for multiple events.

In yet another implementation, the cognitive agent business rule system 100 utilizes WebSocket technology that provides a real full duplex connection. Similar to SSE, the client initiates a request, however the client sends the request to an application server 102 with a special HTTP header that informs the application server 102 that the HTTP connection may be upgraded to a full duplex TCP/IP WebSocket connection. Once the WebSocket connection is established, the connection may be used for bi-direction communication between the client and the application server 102. In such connection, both the client and the application server 102 may communicate with other parties/devices. Hence the Web Socket enables faster exchange of small chunks of data between the client and the application server 102 which may be necessary for gaming and other real-time applications. Further, the API enables communication between additional modules such as display units, perception units like cameras, advanced agents like robots, input processors e.g. image processing, spatial visual agents for scene graphs.

The external devices 110, 112 and 114 may include a communication device 112, a cloud platform 114, a data center 114 or any known electronic device having computational capabilities. Generally, the external devices (110-114) comprise a processor, a control circuitry, input/output module and a communication module which enables communication (for example TCP/IP) between the device and the application server 102. In the present implementation, the application server 102 and the one or more external devices 110, 112 and 114 describes an application architecture in which the external devices (clients) requests an action or service from the application server 102 by means of messages command line interfaces etc. and the application server 102 processes the client requests by performing the tasks requested by the clients and informs the clients about the result of the action by sending response messages/events.

The cognitive agent module 104 hosts business rule engines which in turn runs, composes and manages business rules. Hence the cognitive agent module 104 emulates and/or supports human cognitive capabilities including problem solving, language comprehension, learning, perception and memory.

In one embodiment of the present disclosure, the cognitive agent module 104 is implementation as a web application. The web applications are usually packaged as normal jar file and normally run on the application server 102 and must provide a web.xml. Inside the web.xml, the web application context name must be specified. The war archives also follow a specific directory structure and must contain a WEB-INF folder inside which there is the ‘classes’ and ‘lib’ folders. The META-INF folder is included in the root of the web archive just like jar files. The web applications may have many runtime dependencies on classes provided by other jar files, vendor jar files etc. The web application build process normally handles the copying of the dependencies into the WEB-INF/lib folder of the web application. Such web application first retrieves values from the http request and calls a method on the data access object (DAO) or bean as normal java method calls.

In one embodiment of the present disclosure, the web application/cognitive agent module is modelled as a collection of micro-services rather than a single, monolithic web application. FIG. 1C is an example block diagram illustrating micro-service architecture in accordance with an embodiment of the present disclosure. As shown, the monolithic database architecture (refer to FIG. 1A) is broken into small independent micro-services (units) 122 to 126 that are decoupled and independent. Each unit comprises own database 128 to 132, which deviates from the principle of a monolithic normalized database. Each micro-service 122 to 126 runs a unique process and communicates through a well-defined, lightweight mechanism to serve a business goal. In one implementation, each micro-service communicates with each other using HTTP/REST with JSON. In another implementation, micro-services may also be made available as RPC services to allow them to be called as RPC. Further, the REST formats and the RPC services may be supported by the web application.

In one implementation, the web application is envisaged as a finite state machine that responds to requests from any source such a command line client, a GUI client or another web services. Since the cognitive agent business rule system 100 utilizes REST API for communication, the web application may accept requests from many different clients such as command line clients, GUI clients, web browser clients, third party applications, web services, etc. Further, the web application provides facilities for logging and tracing. The web applications write messages to log files for debugging and knowing that the application is running correctly. Tracing is similar to logging except that tracing may be turned on or off during runtime to debug a running application. Further, the web application provides mechanisms for collecting metrics about running web or other applications and runs health check at regular intervals and monitors the state of the application.

In accordance with an embodiment of the present disclosure, the cognitive agent module 104 applies business rules to imagery and problems that involves spatial and visual processing. Further, the cognitive agent module 104 employs various techniques for implementing behavior and decision making capabilities. In one implementation, the application server (business rules) may be run on more communication devices. In one implementation, the cognitive agent module 104 loads and runs business rules and the agent itself is pluggable so as to allow many different agents to be loaded and run depending on the situation. Which action the cognitive agent module 104 should take for a given situation is specified via a configuration file. [config files are only for configuration. Actions to be taken are specified using other means like rules etc.] The cognitive agent module 104 along with the configuration file must be tightly coupled and run in a coherent fashion to obtain accurate functioning. In another implementation, the cognitive agent module 104 processes the events using pipeline processing method. The process is defined as a pipeline and the data is allowed to flow through the pipeline and get processed. For example, if the business rules agent requires real time data feed of travel flight arrival/departure times, the data may be available as XML from the travel website. The agent fetches the WL, applies some schema validations to the fetched data, may apply an XSLT stylesheet to transform it to a CSV, triples format and add it to its inputlink.

Further, cognitive agent module 104 is a dynamic system with both text, files, API calls all arriving at its input at various times and updates the outputlink to which the agent has to respond. All such operations take place in parallel and the agent processes the events as they arrive in a streamlined fashion.

The manner in which the cognitive agent module 104 operates to perform various tasks to solve problems involving spatial and visual processing is described in detail further below.

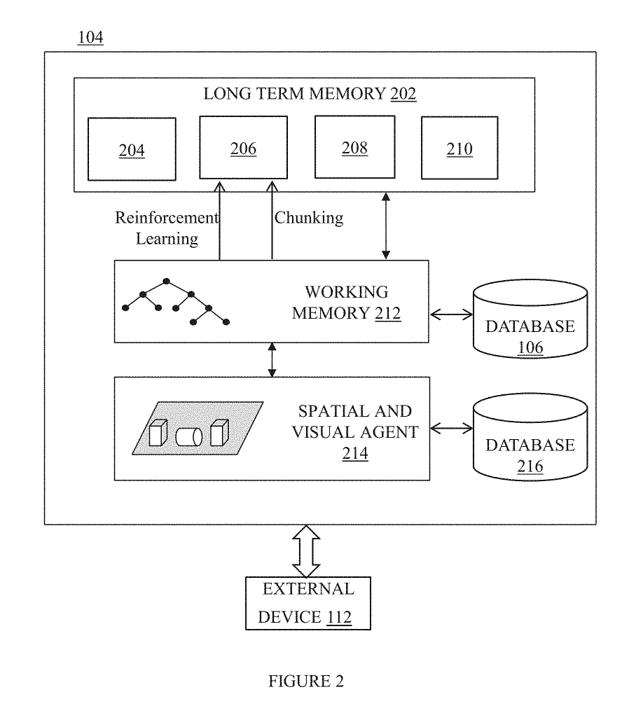

FIG. 2 is a block diagram of an example cognitive agent module 104 for solving problems involving spatial and visual processing in accordance with an embodiment of the present disclosure. As shown, the cognitive agent module 104 comprises a long term memory 202, a working memory 212 and a spatial and visual agent 214 wherein the spatial and visual agent 214 comprises a second database 216. Further, the one or more said modules are coupled to the databases 106 and 216 that stores user input data and the business rules, the preference data, and the episodic data respectively. In one embodiment of the present disclosure, the database 216 stores user data such as audio feeds, video feeds, imagery, semantic data and other big data received by the user.

The long term memory 202 of the cognitive agent module 104 is referred to as production memory. The production memory includes productions or rules, which may be loaded in by a use or generated by the chunking. Each production has a set of conditions and a set of actions. If the conditions of a production match working memory, the production fires, and the actions are performed. The long term memory/production memory 202 contains different memory modules such as preference memory 204, procedural memory 206, semantic memory 208 and episodic memory 210.

The preference memory 204 comprises preferences that select an operator for the working memory 212. Further, the preferences are suggestions or imperatives about the current operator, or information about how suggested operators compare to other operators.

The procedural memory 206 stores the cognitive agents' knowledge of when and how to perform actions based on the user query. The knowledge in the long term memory 202 is represented as if-then rules. The conditions of rules test patterns in the working memory 214 and the actions of rules add and/or remove the working-memory elements. In accordance with an embodiment of the present disclosure, the cognitive agent module 104 supports three forms of learning wherein the three forms of learning include chunking (sub-goal based learning), reinforcement learning (unsupervised learning) and explanation based learning.

In chunking, the cognitive agent module 104 creates a new production, called a chunk. Conditions of the chunk are the one or more elements of the state that allowed the plurality of impasses to be resolved. In other words, the cognitive agent module 104 requires knowledge to solve various problems and acquires knowledge using chunking mechanism. The cognitive agent module 104 learns reflexively when impasses have been resolved. An impasse arises when the system does not have sufficient knowledge. Consequently, the cognitive agent module 104 chooses a new problem space (set of states and the operators that manipulate the states) in a bid to resolve the impasse. While resolving the impasse, the individual steps of the task plan are grouped into larger steps known as chunks. The chunks decrease the problem space search and so increase the efficiency of performing the task.

Reinforcement learning is a trial and error leaning wherein the cognitive agent module 104 learns from consequences of actions and select one or more actions/business rules based on the past experiences (exploitation) and also by new choices (exploration). Generally, a reinforcement learning agent receives a reward/value, which encodes the success of an action's outcome, and the agent seeks to learn to select actions that maximize the accumulated reward over time. Reinforcement learning utilizes Q-values and SARSA methods for scoring the reward value. Q-learning is a model-free reinforcement learning technique and may be used to find an optimal action-selection policy for any given decision process. For example, a state might have “n” number of possible actions and the cognitive agent module 104 learns value (Q—state-action value) of such actions and for each such state the Q value is obtained. Initially, state-action value is set to zero (‘0’) and the action is performed. After performing the action, the state is evaluated and if the action leads to an undesirable outcome, the Q value (or weight) of that action is reduced from that state so that other actions will have a greater value. On the other hand, if the performed action provides desired output, the value of that action for that particular state is increased so that the performed action is used for the next time for the same state.

On the other hand, in SARSA, the main function for updating the Q-value depends on the current state of the agent, the action the agent chooses for the current state, the reward the agent gets for choosing this action, the next state that the agent will now be in after taking that action and finally the next action the agent will choose in its new state.

Hence the cognitive agent module 104 continuously updates the rewards at every stage of processing and for every iteration or run of the cognitive agent module 104/business rules. Further the cognitive agent module 104 finds the optimum solution to a given problem. Such actions are stored in the long term memory 202 for further usage by the cognitive agent module 104. On the other hand, the cognitive agent module 104 uses said rewards/values to select best possible match for the business rule to execute that leads to a solution. Further, the explanation based learning suggests that a new concept is acquired and learning occurs through progressive generalizing.

The semantic memory 208 provides the ability to store and retrieve declarative facts about the queries/query environment (world) and the semantic memory 208 is built from structures that occur in the working memory 214. The representation of knowledge in the semantic memory 208 includes graph structures that are composed of symbolic elements consisting of an identifier, an attribute, and a value. However, the semantic memory 208 contains knowledge, independent of when and where the knowledge was learned from the working memory 214. On the other hand, the episodic memory 210 contains knowledge of what was experienced over time and the episodic memory 210 is built up by snapshots of working memory, providing the ability to remember the context of past experiences as well as the temporal relationships between experiences.

In an embodiment of the present disclosure, the cognitive agent module 104 represents the current problem-solving situation in the working memory 212. Thus, the working memory 212 holds the current state and the one or more operators and is a short-term knowledge, that reflects the current knowledge of the world and status in the problem solving. The one or more elements in the working memory 212 are referred to as working memory elements (hereinafter ‘WME’). Each WME contains a very specific piece of information. Several WME's collectively may provide more information about a same object.

In accordance with an embodiment of the present disclosure, the cognitive agent's 104 WMEs operates on the principle of state graph and processes the user queries in one or more phases wherein the one or more phases may include input phase, elaboration phase, operator proposal phase, operator application phase and an output phase. Generally, the state graph is composed of nodes and edges, together referred to as symbols. Hence the cognitive agent module 104 works on the information provided to the state graph wherein the information may be accessed from other sources such as semantic memory, episodic memory etc.

In one embodiment of the present disclosure, the cognitive agent module 104/working memory receives user queries through an InputLink in the input phase wherein the user queries may include business problems involving financial matters, problems involved in imagery, problems that involve spatial and visual processing etc. In another embodiment of the present disclosure, the application server 102 utilizes various adapters that grabs information from various sources and adds them to the InputLink, however, most of the information is obtained by REST APIs and even some data is collected via Screengrab, Webscraping etc. The data is transformed from web formats like XML, JSON etc. into triples before adding to the InputLink. It has to be noted that the inputlink only receives text inputs, however, spatial and visual queries are added to the spatial and visual agent through one or more external devices. In one embodiment of the present disclosure, the spatial and visual queries are added to the spatial and visual agent as a scene graph and the spatial and visual agent generates a state graph/symbolic representation which are added to the inputlink of the working memory. As described, the application server 102 obtains most of the information by REST APIs and even some data is collected via Screengrab, Webscraping etc. In webscraping, the contents are aggregated for indexing and searching. In one implementation, the webscraping comprises building an index of websites to be searched, creating bots which may visit a site and index its content, aggregating the content on the application server and providing search facility for the content. In yet another embodiment, the cognitive agent module 104 is deployed on a distributed computing environment such as Hadoop™ enabling the system of the present invention to receive and process the queries using MapReduce operations. This is particularly advantageous since on distributed computing platforms, vast amount of unstructured data such as objects, images, videos etc can be stored and processed.

One exemplary application of the present disclosure is found in computer assisted solving of Rubik's cube puzzle. While several algorithms are known in the art for solving the Rubik's cube puzzle in different ways, such as shortest time, least number of moves etc. Embodiments of the present disclosure enables three dimensional visualization of the cube to assist the user in solving the puzzle. Since it is always desirable to visualize the moves to the user, the present disclosure provides means to achieve this. The spatial and visual processing module identifies and assigns value to each of the one or more edges and faces of the cube at an initial position. Further, the spatial and visual processing module applies scaling transformation. Moreover, each cubelet of the cube is assigned an identifier and the coordinate system of the cube and cubelets is transformed to the center of the cube.

An exemplary arrangement for the cubelets and their ids for each layer front to back is shown below:

| Front face | | | Middle face | | | Back face | | |
|---|---|---|---|---|---|---|---|---|
| 000 | 001 | 002 | 100 | 101 | 102 | 200 | 201 | 202 |
| 010 | 011 | 012 | 110 | 111 | 112 | 210 | 211 | 212 |
| 020 | 021 | 022 | 120 | 121 | 122 | 220 | 221 | 222 |

This makes it possible to iterate over the cube and select the different faces e.g left, front, top, back etc. For example, the left face has col=0, top face has col=0, bottom face has row=2 and so on.

In the current exemplary application, the system further accepts a list of faces, a face name and orientation. The faces Map contains a list of all the faces of the cubelet for the side the user has selected to rotate keyed by the face name. The faceName contains the face the user wishes to rotate. Our design of the cube is front facing. This means that the cube front is always the forward facing face even if it is a left or right side cubelet. The side the user wishes to rotate will contain a flat face which could be any of front, left, right, top, bottom or back. Each flat face would have adjacent side faces top, left, bottom and right. The orientation can be clockwise or anticlockwise.

As described, the cognitive agent module 104 applies business rules to imagery and problems that involve spatial and visual processing. In one embodiment of the present disclosure, video feeds, photos and other visual inputs may be added to the InputLink (through spatial and visual agent) of the cognitive agent module 104 through spatial and visual agent and suitable intermediary systems such as image recognition, image processing etc. wherein the spatial and visual agent generates state graph from the scene graph and then the state graph is added to the inputlink. In another embodiment of the present disclosure, the intermediary systems and/or the APIs generates symbolic representations from the visual scene and the generated state graph/symbolic representation is added to InputLink and hence to the cognitive agent module 104.

In elaboration phase, the cognitive agent module 104 adds a plurality of elaborations to the state graph. Further, the cognitive agent module 104 selects one or more operators for execution. The one or more operators are selected based on a preference of a plurality of preferences in a preference memory 204 and the semantic memory 208. The preference is an imperative associated with an operator of one or more operators.

In accordance with an embodiment of the present disclosure, the cognitive agent module 104 initiates the spatial and visual agent 214 if the user query (problems) involves spatial and visual tasks and provides an external interface to the outside world for all spatial and visual tasks. In one embodiment of the present disclosure, the external environment perceives the scene via camera and/or any image processing devices and the perceived scene is sent to the spatial visual agent 214 in a format of a scene graph or JavaFX scene graph.

The spatial visual agent 214 also supports adding raw images in popular formats such jpg, gif, png, svg, bitmap etc. and provides built in codecs for other various formats and the users may add many more to the spatial and visual agent 214. In one implementation, the spatial and visual agent 214 provides various functions for manipulating the scene graphs, scenes etc. and generates a polyhedral model of the scene in a special area of memory called spatial memory. Further, the spatial and visual agent 214 maintains an image buffer to draw a color representation of the scene. Hence using the polyhedral model any object in the scene may be modified for example may be translated (moved), rotated or scaled (made larger or smaller) etc.

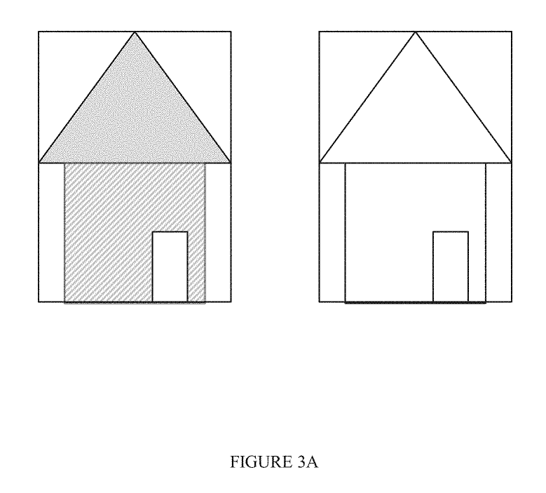

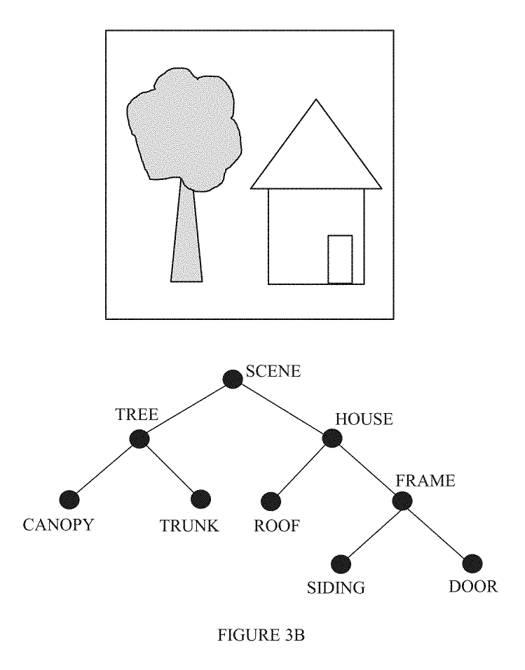

FIGS. 3A and 3B illustrates an exemplary processing by the spatial and visual agent 214 in accordance with an embodiment of the present disclosure. Generally, a house for example is a composite structure with many sides, faces, slanting roof, towers, pinnacles etc. As shown in FIG. 3A, a polyhedral model of the house is the largest rectangle that encloses all the points on the house itself. Any operation on the polyhedral model applies to the house as well. As the polyhedral model moves, so does the house. As the polyhedral model scales, so does the house.

FIG. 3B illustrates an example scene and scene graphs derived from the scene. As shown, the scene contains a house and a tree. The scene graph indicates a scene containing a tree and a house wherein the tree further comprises canopy and trunk. On the other hand, the house comprises roof and frame wherein the frame further comprises siding and door. Now referring to FIG. 3B, in one embodiment of the present disclosure, the spatial and visual agent 214 encodes the scene graph into working memory 212 of the cognitive agent module 104 as a state graph/transform object. The manner in which the state graph is created from the scene graph is described in detail further below.

The spatial and visual agent 214 creates a spatial node that is added to the top state for the spatial and visual agent 214 related symbols. The spatial node has a “spatial-scene.object.id” called scene which corresponds to the scene. Under the scene there are two objects which should have been House and Tree as the scene contains only a house and a tree. Since, spatial symbols are not added directly, instead of two symbols, “transform-child tree-transform” and “transform-child house-transform” symbols are added, which are the corresponding transform objects. Hence, the spatial and visual agent 214 may execute spatial transforms (translation, rotation, scaling) on symbols or objects. However, these transformations may be real or imaginary.

Further, the house and tree symbols are under the transform nodes as object-child links. Each object in spatial and visual scenes must have a unique id represented as ‘id’ in the state graph. In addition, some spatial visual scenes may be persisted in the database, file etc. and are assigned a class-id. The spatial and visual agent 214 retrieves the scenes from LTM using the class-id attributes. The final state graph/transform object which is encoded in the working memory 212 of the cognitive agent module 104 is shown below.

sys.spatial-scene.object.id scene

.transform-child tree-transform

.transform-child house-transform

.transform.id tree-transform

.object-child tree

.transform.id house-transform

.object-child house

.object.id tree

.class-id tree-type-37

.object.id house

.class-id tree-type-24

In one embodiment of the present disclosure, the transform object is exported to web application running on the client device. The transform object in a java context is called a Java Bean. The java bean in an instance of the scene class which acts as a template for the java bean. In web application, a dynamic UI binder loads the scene which may be displayed via a HTML form with input fields, buttons etc.

In one example, a user can create a ball bean object using an external web application such as a GUI designer. In this example, the characteristics of the object such as the size of the ball, colour of the ball, its position on screen, rotation characteristics etc. together known as its state are maintained in the working memory, possibly a ball object which represents the ball in memory inside the application. This object in a java context is called a Java Bean, and more precisely a Ball bean object. The Ball bean object is an instance of the Ball class which acts as a template for the Ball bean object. Further, in the current example it is to be noted that in a static environment, both the ball bean.ui.xml and the ball bean.ui.class may be made available at the run time. Furthermore, in the dynamic environment, the user may choose to upload design artifacts consisting of a html template and optionally a CSS file or a Javascript file.

In the dynamic environment, the application server 102 enables dynamically loading classes at runtime and further the client side dynamic UI binder causes loading of HTML templates chosen by the user for generating the UI scene.

In one embodiment of the present disclosure, the cognitive agent module 104 executes plurality of business rules based on the state graph. The selecting engine selects one or more operators for execution. The one or more operators are selected based on a preference of a plurality of preferences in a preference memory 204. The preference is an imperative associated with an operator of the one or more operators. The application module applies actions of production on an operator of the one or more operators. The actions of production can be applied by adding and removing an element of the plurality of elements. The plurality of preferences includes at least one of an acceptable preference, a reject preference, a better/worse preference, a best preference, a worst preference, an indifferent preference, a numeric-indifferent preference, a require preference and a prohibit preference.

In the cognitive agent module 104, when the preference of the plurality of preferences in the preference memory cannot be resolved unambiguously, the cognitive agent module 104 reaches an impasse. Further, when the cognitive agent module 104 is unable to select a new operator (in the decision cycle), it is said to reach an operator impasse. In the cognitive agent module 104, all the impasses appear as the states in the working memory 212, where the states can be tested by productions.

As described, a plurality of impasses arises from the plurality of preferences. And the plurality of impasses includes a tie impasse, a conflict impasse, a constraint-failure impasse and a no-change impasse. In one embodiment of the present disclosure, the cognitive agent module 104 handles the plurality of impasses by creating a new state in which a goal of the problem solving is to resolve the impasse of the plurality of impasses. Thus, in a sub-state, the one or more operators are selected and applied in an attempt either to discover which of the tied operators should be selected, or to apply the selected operator piece by piece. The sub-state is often referred to as a sub-goal because the sub-state exists to resolve the impasse of the plurality of impasses.

Generally, the business rules executed by the cognitive module 104 comprise condition part and action part. When the business rule conditions match the set of facts and data present on the state graph, the rules fire and execute the action part. The action part makes the changes to the state graph and may cause one or more rules to fire. Hence the business rules run towards until a solution is obtained and the output is sent as events to the event listener of the one or more external device 110, 112 and 114.

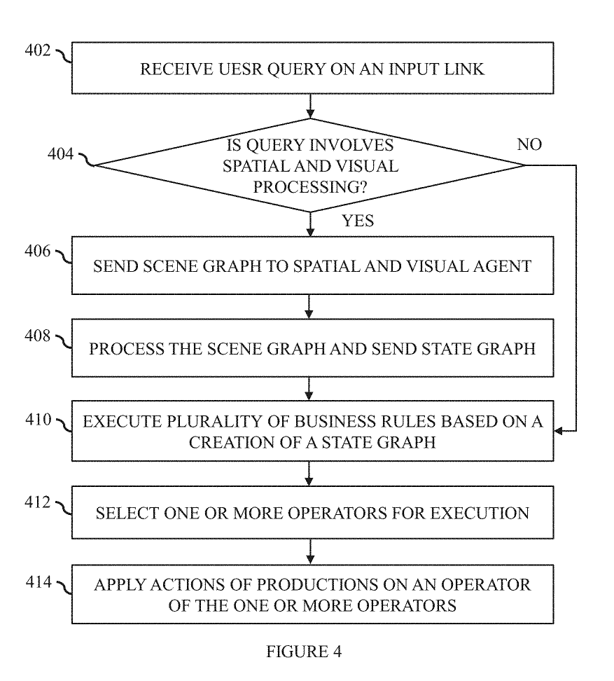

FIG. 4 is a flowchart describing the execution of the plurality of business rules by the cognitive agent module 104 in accordance with various embodiments of the present disclosure. The flowchart initiates at step 402 wherein the cognitive agent module 104 receives user queries form the one or more external devices wherein the user queries are received through one or more application program interfaces (APIs) for example REST API.

On receiving the user queries, the cognitive agent module 104 identifies the query and check whether the query involves spatial and visual processing as shown in step 404. If the input is text, then the control passes to step 410. Else if the query involves spatial and visual processing then the control passes to step 406.

In one embodiment of the present disclosure, at step 406, the external environment perceives the scene via camera and/or any image processing devices and the perceived scene is sent to the spatial visual agent 214 in a format of a scene graph or JavaFX scene graph as shown in step 406.

In step 408, the spatial and visual agent 214 processes the received scene graph and generates a state graph wherein the generated state graph/transform object is encoded into the working memory 212. In accordance with an embodiment of the present disclosure, the cognitive agent module 104 creates a new production, called a chunk. Conditions of the chunk are the one or more elements of the state that allowed the plurality of impasses to be resolved.

Following step 408 or 404, at step 410, the cognitive agent module 104 executes plurality of business rules based on the creation of the state graph. The state graph is created by adding the plurality of nodes and the plurality of attributes to the top level state. At step 412, the cognitive agent module 104 selects the one or more operators for execution. The one or more operators are selected based on a preference of the plurality of preferences in the preference memory 204. The preference is the imperative associated with an operator of the one or more operators. At step 414, the cognitive agent module 114 applies the actions of productions on an operator of the one or more operators. The actions of productions may be applied by adding and removing the elements. When multiple operators are proposed, each operator is associated with a real value that is constantly updated. In one embodiment of the present disclosure, the cognitive agent module 104 uses the said values to select best possible match for the business rule to execute that leads to a solution. In other words, the cognitive agent module 104 utilizes a trial and error leaning method wherein the cognitive agent module 104 learns from consequences of actions and selects one or more actions/business rules based on the past experiences (exploitation) and also by new choices (exploration). The flowchart terminates at step 416.

It may be noted that the flowchart is explained to have above stated process steps; however, those skilled in the art would appreciate that the flowchart may have more/less number of process steps which may enable all the above stated embodiments of the present disclosure. An example of solving Sudoku through 3D grid is described in detail further below.

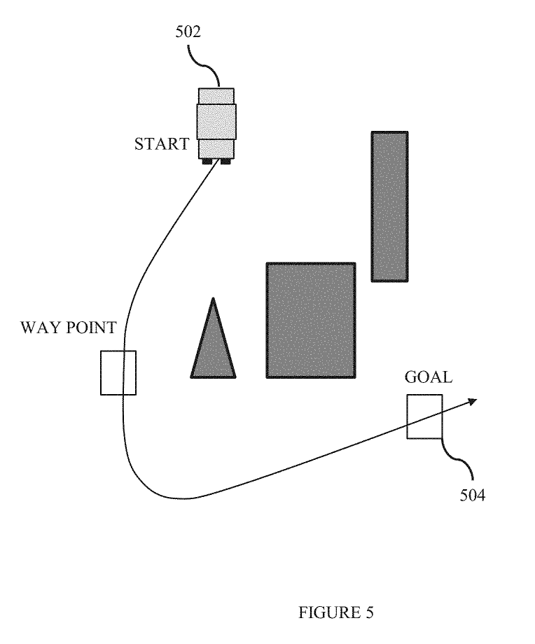

Now referring to the FIG. 5, one of the applications of the cognitive agent module 104 and the spatial and visual agent 106 in autonomous driving vehicles is described. As illustrated in the FIG. 5, a visual representation of an autonomous car 502 and the path that the car 502 has to follow to reach the destination/goal 504 is depicted. The visual representation or live video feed is input to the spatial visual agent 214 by the external device 112, for e.g. a computing device integrated with the autonomous car of the present example. The spatial visual agent 214 generates symbolic representation/transform objects using the input provided in order to identify car as a transform object and the destination as the goal. Then the spatial and visual agent 214 encodes the transform object/symbolic structures into working memory of 212 of the cognitive agent module 104.

In accordance with an embodiment of the present disclosure, the cognitive agent module 104 stores the symbolic structure in working memory 212. Further, the cognitive agent module 104 proceeds by adding new random point objects/nodes to the scene and querying for the distance from each node to the goal 504. Thus generated distances are then compared to find the closest path to the goal. Then a simulation in instantiated with starting from the first node (car position) and the simulation is stepped until the goal is reached or obstacle/collision is found. If an obstacle is found, the cognitive agent module 104 extends the tree by generating new nodes towards the goal, bypassing the obstacle.

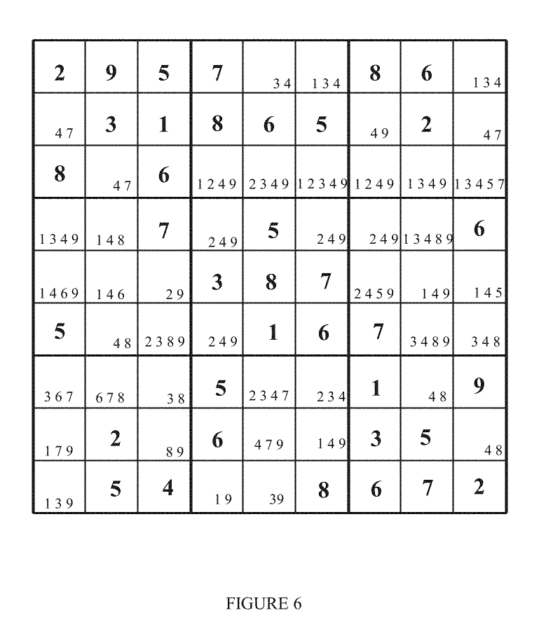

FIG. 6 illustrates an example Sudoku puzzle with marked-up cells. In one implementation, an algorithm represents the Sudoku board as a 3D grid with each number represented by its binary 8-bits equivalent for example ‘1’ as “00000001”, ‘2’ as “00000010” and so on.

Similarly, each row and column of the 3D grid is represented as a binary sequence for each binary digit (1 to 9), the sequence may take only values ‘1’ or ‘0’ and one digit of the binary sequence may be true (1) at any time. In one embodiment of the present disclosure, the cognitive agent module may select a row/column to solve depending on the board state. In the first step, the cognitive agent module jot down for each cell for identifying which number may occupy that particular cell based on the board state. The first step is done once at the start of the provided clue and repeated after every cycle when the cognitive agent module updates a cell value. Now referring to FIG. 5, considering 7^{th} row, for each binary digit (number 1 to 9), the algorithm writes down 9 binary sequences. In the binary sequences, the presence of ‘1’ does not indicate the number but whether the number may occupy a particular cell and hence presence of ‘1’ indicates that the number (1 to 9) might occupy.

For example, in row 7, ‘1’ is a clue provided in cell ‘7’ and so cannot occupy anywhere else in that row. Hence, ‘1’=000000100.

Similarly for 2, ‘2’ may occupy cells ‘5’ or ‘6’. Hence ‘2’=000011000. Similarly, ‘3’=101011000, ‘4’=000011010, ‘5’=000100000, ‘7’=110000000, ‘8’=011000010 and ‘9’=000000001. Since, 5, 1 and 9 are provided as clues, no number can occupy in these cells (cells 5, 6 and 9) and hence said cells are replaced with ‘0’.

Now, the algorithm finds out contenders for each number from 1 to 9. For example, number ‘4’ may occupy 5, 6, 8 cells and hence contenders for number ‘4’ in cell 5 are 2, 3 and 7, contender in cell 6 are 2 and 3, and contender in cell 8 is 8. Since the number ‘4’ has minimum contenders in cell 8, the number ‘4’ is assigned to cell ‘8’. Further, the process is repeated for all the numbers (1 to 9) of each row and/or column for solving the given problem.

In the above example, the user query is to solve the Sudoku puzzle. On receiving the user query, the spatial and visual agent 214 creates a scene graph and encodes the scene graph into working memory 212 of the cognitive agent module 104. The cognitive agent module 104 marks up each cell and solve the puzzle by identifying the contenders. In one implementation, on solving a particular cell, the cognitive agent module 104 updates the episodic memory 210 for further processing and solving the problem.

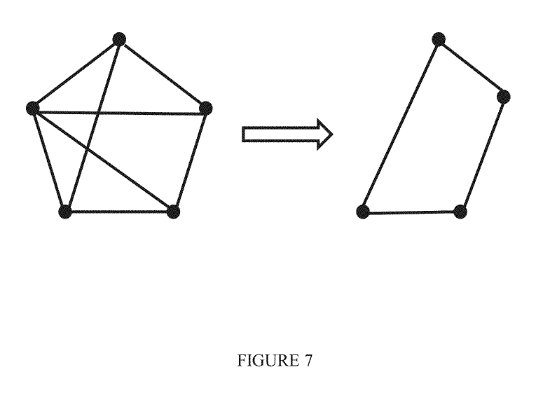

In yet another example, the cognitive agent business rules system 100 of the present disclosure finds application in sub graph search where the problem is to search through a data graph for occurrence of another graph, typically referred to as a query graph. The sub graph search is solved by the application of sliding window technique in spatial visual agent 106 such that the spatial visual agent receives the query graph via one or more external devices and creates transform objects using imaginary coordinates for the query graph. Similarly, the original data graph is processed and sent to the cognitive agent module 104 to determine the match. FIG. 7 illustrates an example sub graph search method in accordance with an embodiment of the present disclosure.

The cognitive agent business rule system 100 disclosed in the present disclosure provides a platform for creating a cognitive agent module for resolving real world problems including spatial and visual processing. Further, the cognitive agent module may be accessed from web applications, via mobile applications and from other applications (apps running JavaScript) using APIs for example REST API.

Furthermore, the cognitive agent business rule system 100 adds imagery in addition to symbolic representation using spatial and visual agent. Accordingly, video feeds, photos and other visual input may be added to the spatial and visual agent through scene graphs and the symbolic representation of the scene graph is added to the input link of the cognitive agent module. In accordance with an embodiment of the present disclosure, the scene graphs may be added to the spatial and visual agent by means of suitable intermediary systems such as image recognition, Image processing etc. Hence, the cognitive agent business rule system 100 may be used for various applications such as perimeter monitoring, vehicle navigation, CCTV systems, gaming, space observation etc.

The business rules agent is generally used as part of a larger system comprising of a workflow, imaging and business rules engine. The workflow engine makes calls out to the business rules system for making decisions. The cognitive agent business rules system of the present disclosure can also be configured to function as a Business Process Management (BPM) Agent. The BPM agent thus will provide much enhanced functionality of process management in addition to rules.

The written description describes the subject matter herein to enable any person skilled in the art to make and use the embodiments of the invention. The scope of the subject matter embodiments are defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

We claim:

1. A cognitive agent business rules system comprising:
an application server in communication with one or more external devices, wherein the application server further comprises:
a cognitive agent module, configured to compose and execute a plurality of business rules;
at least a first database for storing a one of preference operators, an episodic data and the like, wherein the at least first database is in communication with the cognitive agent;
a second database for storing a visual data received from and to be sent to the external devices; wherein the cognitive agent processes the visual data using one or more operators and episodic data received from the first database.

2. The cognitive agent business rules system as claimed in claim 1, wherein the cognitive agent module comprises a spatial visual agent, configured, to process the visual data for generating perceptions, decisions and the like.

3. The spatial visual agent of the cognitive agent, as claimed in claim 2, wherein the spatial visual agent receives the visual data from one or more external devices in the form of a scene graph and creates one or more transform objects.

4. The cognitive agent business rules system as claimed in claim 1, wherein the cognitive agent module comprises a working memory configured to receive the one or more transform objects from the spatial visual agent to be operated by the one or more operators.

5. The spatial visual agent of the cognitive agent as claimed in claim 2, wherein the spatial visual agent receives the scene graph from an image processing unit which is in communication with the external device such as a camera, a distributed computing network, a web scrapping module, a video feed and the like.

6. The cognitive agent business rules system as claimed in claim 4, wherein the working memory of the cognitive agent receives the input through an application programming interface (API) of the application server.

7. The spatial visual agent as claimed in claim 3, wherein the transform object, processed in the working memory, is represented as symbols corresponding to the spatial and visual objects as processed by the spatial visual agent.

8. A computer implemented method comprising:
composing and executing, by a cognitive agent module of an application server in communication with one or more external devices, a plurality of business rules;
storing, with at least a first database, a one of preference operators, an episodic data and the like, and wherein the at least first database is in communication with the cognitive agent;
storing, with a second database, a visual data received from and to be sent to the external devices; wherein the cognitive agent module processes the visual data using one or more operators and episodic data received from the first database.

9. The computer implemented method as claimed in claim 8, wherein the cognitive agent module comprises a spatial visual agent, configured, to process the visual data for generating perceptions, decisions and the like; and
a working memory.

10. The computer implemented method as claimed in claim 9, wherein processing the visual data for generating perceptions comprises:
receiving the visual data from one or more external devices in the form of a scene graph;
creating one or more transform objects; and
encoding the transform objects into the working memory.

11. The computer implemented method as claimed in claim 10, wherein receiving the visual data from one or more external devices in the form of a scene graph includes receiving from an image processing unit which is in communication with the external device such as a camera, a distributed computing network, a web scrapping module, a video feed and the like.
